(19) United States
(12) Patent Application Publication
(10) Pub. No.: US 2004/0159408 A1
(43) Pub. Date: Aug. 19, 2004

(54) Raisable panel

(76) Inventors: Park B. Smith, New York, NY (US); Linda Johnson, New York, NY (US)

Correspondence Address: Lew Reff, Coudert Brothers LLP, 1114 Avenue of the Americas, New York, NY, 10036, US

(21) Appl. No.: 10/773,635

(22) Filed: Feb. 6, 2004

Related U.S. Application Data
(60) Provisional application No. 60/445,754, filed on Feb. 7, 2003.

(51) Int. Cl. E06B 3/48

(52) U.S. Cl. 160/84.01

(57) ABSTRACT

The present invention is directed to a non-ballooning raisable fabric panel that can be easily installed on or uninstalled from a rod, such as a conventional curtain rod. In one embodiment, the panel can be easily installed by sliding a rod through a sleeve positioned at or near the top of the panel. Installation of the present invention is completed without using collateral hardware typically used in installing fabric panels over a window or from a ceiling, for example.

### I. CROSS REFERENCE TO RELATED APPLICATIONS

This application claims priority under 35 U.S.C. § 119 from U.S. Provisional Application Serial No. 60/445,754, filed Feb. 7, 2003, which is incorporated herein by reference in its entirety. This application is also a continuation-in-part application of Appl. Nos. 29/184,069; 29/184,070; 29/184,071, 29/184,172; 29/184,173; and 29/184,174, filed Nov. 21, 2003. Each of these applications is herein incorporated by reference in their entirety.

### II. BACKGROUND OF THE INVENTION

Raisable fabric panels, such as window treatments, are typically made of a foldable material such as a natural or synthetic fabric. Raisable fabric panels are typically drawn with pull cords guided by string guides, such that the panel may be raised or lowered by progressively raising or lowering the pull cords, respectively. Raisable panels may be used for decoration, to filter light, add privacy and/or block air drafts, for example.

Raisable fabric panels, such as conventional window treatments (e.g., Roman Shades) have been installed by mounting a board and/or affixing hardware that are screwed onto the top of the inside of a window frame or door frame. Installation usually requires the use of hooks, brackets and the like. Further, the standard installation process commonly requires the use of measuring tape, power drill/drill bits, Hex head or Philips screw driver bits and other tools which may not be readily available to the user. Thus, installation is often complex, awkward and time-consuming. In many instances the installation process cannot be completed by a home owner.

Moreover, raisable panels, e.g., a Roman shades, are very labor intensive to manufacture. For example, because window treatments (e.g. Roman shades) must be mounted inside the window frame, window treatments manufactured to fit conventionally sized windows cannot be used relative to unconventionally sized windows. While window treatments can be custom-made to fit a particular window, the process is often cost-prohibitive and commonly labor intensive; and consequently, time consuming. Moreover, conventional window treatments e.g., Roman Shades, are often not reusable. Once installed, it is difficult or time consuming to remove the window treatment particularly its hardware components that are affixed (screwed onto) door or window frames. If the window treatment cannot be uninstalled, or is damaged when uninstalled, then it cannot be used again. Typically, the hardware for one window treatment is not suitable for another. Thus, to replace window treatments, one must remove the old hardware and replace it with new hardware, typically custom made for the replacement window treatment.

Currently, “Tuck Adjustable Pull-Up Blind” and “Pull-Up Cotton Shade” window treatment products are commercially available (Umbra, Inc., USA). These products must be hung by a specially designed rod having special rings welded on to the special rod. These products also require collateral hardware to complete installation in a window frame. Specifically, the Tuck Adjustable Pull-Up Blind must be suspended on a special rod sold with the blind. Also, the user must install special brackets sold with the blind for suspending the special rod. Further, certain of these products, when raised, give a billowing, ballooning or swaging appearance, which may not be desirable by the consumer. The present invention is distinguishable over those products in other respects.

Accordingly, there is a need for non-custom made raisable panel, such as a window treatment (e.g., Roman Shade) which can be easily installed and uninstalled without the use of collateral hardware. There is also a need for a raisable panel, e.g., window treatment, which may be installed on the outside or inside of a window frame without the use of collateral hardware, thereby allowing the shade to accommodate a variety of window sizes and drops further giving the user greater flexibility in installation. There is also a need for a raisable panel which can be reused (e.g., slid onto a previously installed curtain rod) without the use of collateral hardware.

Moreover, there is a need for a raisable panel (e.g., Roman shade) suitable for installing on a conventional rod, wherein the window treatment, when raised, does not have a ballooning (e.g., billowing or poufing) or swag appearance, nor has folds or bends like an accordion, nor does it produce unsightly wrinkles. Further, there is a need for such a window treatment that can be mass manufactured.

### III. SUMMARY OF THE INVENTION

The present invention is directed to a raisable panel, such as a window treatment (e.g.,. Roman shade) that can be easily installed on or unistalled onto a conventional rod without the need of collateral hardware typically used for installing raisable panels. In one embodiment, the present panel, when raised, forms a series of predetermined horizontally stacking pleats without ballooning or swaging nor does it form folds or bends resembling an accordion, nor does it produce unsightly wrinkles. Further, the panel of the present invention is suitable for mass production, and it can be reused without the use of collateral hardware.

Also, the present invention provides a novel raisable panel comprised of a prestrung article configured to enable convenient handling and shipping, such as for mail-order sale, and yet which facilitates installation.

### IV. BRIEF DESCRIPTION OF DRAWINGS

The raisable panel shown in the following drawings are representative of alternative embodiments of the present invention. The drawings herein are not intended to limit the scope of the present invention. They are presented for illustrative purposes only.

FIG. 1 is a view of a backside of a raisable panel of the present invention fully open.

FIG. 2 is a perspective view of the top left corner of the backside of a raisable panel of the present invention.

FIG. 3 is a view of the top left corner of the backside of a raisable panel of the present invention.

FIG. 4 is a partial view of the present invention showing a pull cord through a guide element.

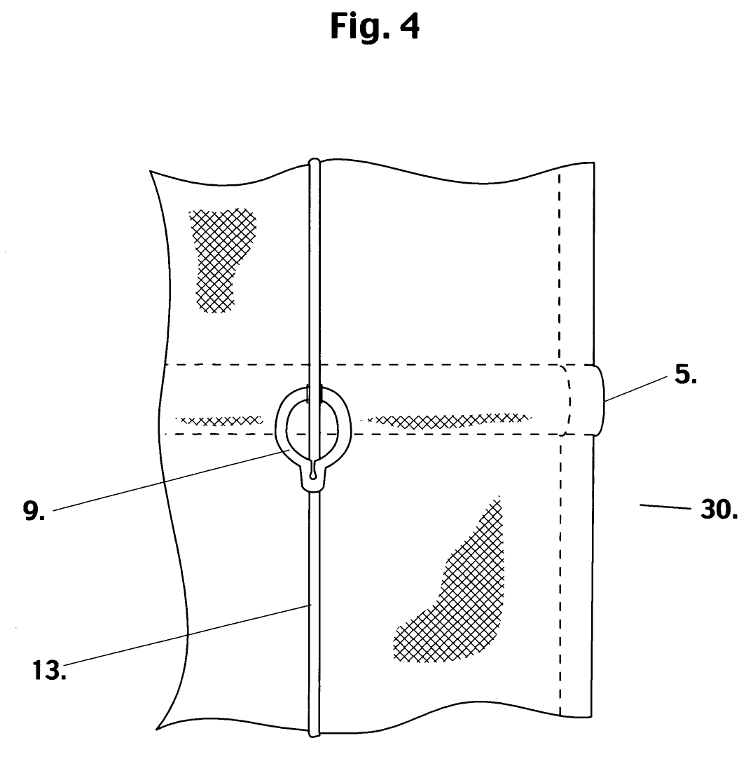

FIG. 5 is a front side view of a partially-drawn raisable panel of the present invention.

FIG. 6 is a view of a backside of a raisable panel of the present invention fully open.

FIG. 7 is a view of a backside of a raisable panel of the present invention fully open.

FIG. 8 is a front side perspective view of a raisable panel of the present invention partially drawn.

FIG. 9 is a back side perspective view of the raisable panel of the present invention partially drawn.

FIG. 10 is a front side perspective view of the raisable panel of the present invention fully drawn;

FIG. 11 is a back side perspective view of the raisable panel of the present invention fully drawn;

FIG. 12 is a front view of the raisable panel of the present invention fully drawn.

FIG. 13 is a back view of the raisable panel of the present invention fully drawn;

FIG. 14 is a top view of the raisable panel of the present invention fully drawn;

FIG. 15 is a bottom view of the raisable panel of the present invention partially drawn;

FIG. 16 is a front side view of the raisable panel of the present invention partially drawn.

FIG. 17 is a side elevational view of the raisable panel of the present invention partially drawn.

FIG. 18 is a front side perspective view of the raisable panel of the present invention partially drawn.

FIG. 19 is a back side perspective view of the raisable panel of the present invention partially drawn;

FIG. 20 is a front side perspective view of the raisable panel of the present invention fully drawn;

FIG. 21 is a back side of perspective of the raisable panel of the present invention fully drawn.

FIG. 22 is a view of the front side of the raisable panel of the present invention fully drawn;

FIG. 23 is a back view of the raisable panel of the present invention fully drawn;

FIG. 24 is a top view of the raisable panel of the present invention fully drawn;

FIG. 25 is a bottom side view of the raisable panel of the present invention fully drawn;

FIG. 26 is a front side view of the raisable panel of the present invention partially drawn.

FIG. 27 is a front side perspective view of the raisable panel of the present invention partially drawn.

FIG. 28 is a back side perspective view of the raisable panel of the present invention partially drawn;

FIG. 29 is a front side perspective view of the raisable panel of the present invention fully drawn;

FIG. 30 is a back side view of the raisable panel of the present invention fully drawn.

FIG. 31 is a view of the front side of the raisable panel of the present invention fully drawn;

FIG. 32 is a back view of the raisable panel of the present invention fully drawn;

FIG. 33 is a top view of the raisable panel of the present invention fully drawn;

FIG. 34 is a bottom view of the raisable panel of the present invention fully drawn.

FIG. 35 is front side of the window treatment of the present invention partially drawn; and

### V. DETAILED DESCRIPTION OF THE INVENTION

1. Panel

The present invention is directed to a raisable panel (25) suspendable from a rod (14). The term “panel” as used herein includes, but is not limited to, window treatments, such as, fabric panels, shades, or blinds. The term “panel” may also include room dividers, wall hangings or any other decorative item suspendable from a rod. In one embodiment, the panel (25) comprises a horizontally extending top (27). It may also comprise a horizontally extending bottom (28). The panel (25) also comprises a front side (29) and a rear side (30). In one embodiment, the panel (25) may be generally rectangular. The bottom edge (22) of the panel may be planar.

The panel (25) may be made of flexible, partially flexible, or non-flexible material. The panel (25) may comprise any material suitable for making window treatments, room dividers, wall hangings or any other decorative item suspendable from a rod, including, but not limited to, drapery fabric, curtain fabric, wood, jute, upholstery fabric, textile fabric, natural fiber fabrics, cotton, linen, muslin, silk, rayon, wood, bamboo, metal and synthetic fiber fabrics, such as for example polyester, nylon, plastic, natural or any other man-made material or any combination thereof. The panel (25) may be provided in a variety of solid colors or with printed or embroidered patterns to match a wide range of decors. Other materials may include, but are not limited to velvet, corduroy, canvas, suede, damask, chenille, leather, dobby, jacquaran, or tapestry.

Approximate dimensions of the panel may include, but are not limited to the following (L×W): 30×75; 35×75; 40×75; 52×75; 72×75; 40×72; 30×72; 40×84; 30×72; 40×84; 30×84; and 72×84.

2. Rod

The panel (25) of the present invention is suspendable from a rod (14). As used herein, the term “rod” includes any pole, rod, stick or shank suitable for hanging window treatments, wall hangings, room dividers, or other suspendable decorative materials. Rods suitable for use include, but are not limited to, conventional curtain rods, including single and double curtain rods, cafe rods, wooden rods, metal rods, plastic rods, clear plastic rods, combination rods, continental rods, traverse rods, extender curtain rods, multiple draw rods, one-way rods, two-way rods, pole sets, sash rods, spring tension rods, wood pole sets and the like.

3. Rod Receiving Sleeve

In one embodiment, the panel of the present invention also comprises a sleeve (1) for receiving the rod (14) to install and suspend the panel (25) over at least a portion of a window, such as, for example, the top of the window or portion thereof. In one embodiment, the sleeve (1) may extend laterally along the top (27) of the panel (25) to enable insertion of the rod (14) through the sleeve (1). In one embodiment, the sleeve (1) may be made of the same material as the panel (25). In another alternative embodiment, the sleeve (1) is made of a material different from that of the rest of the panel (25).

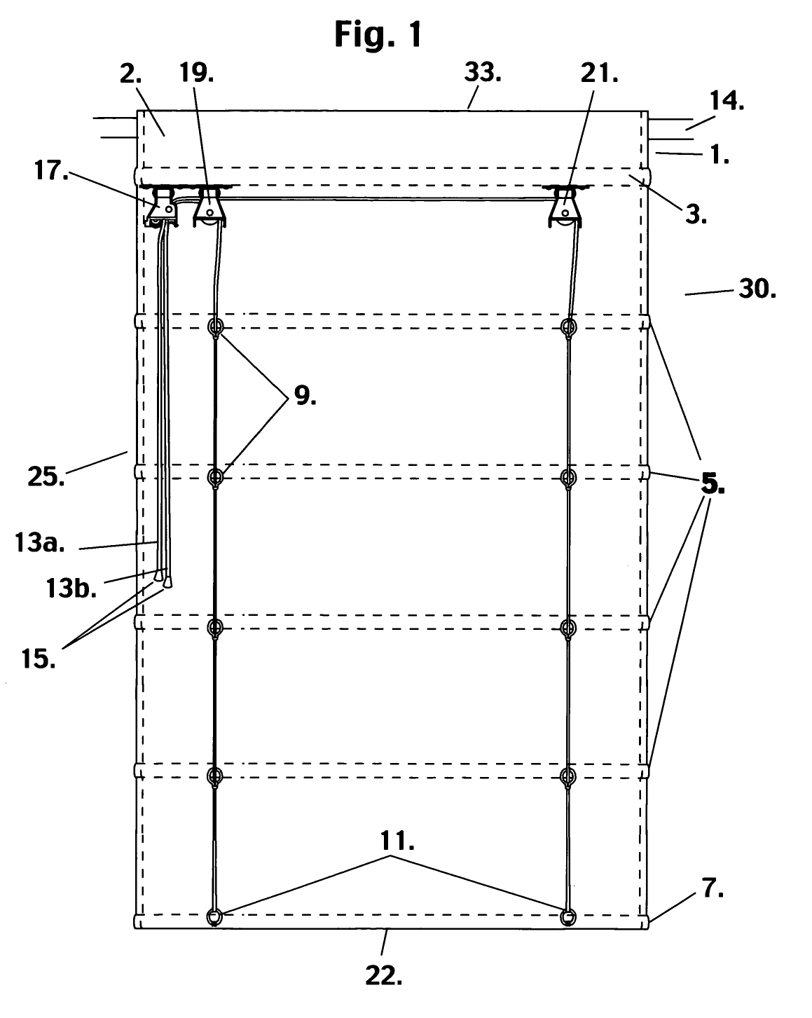

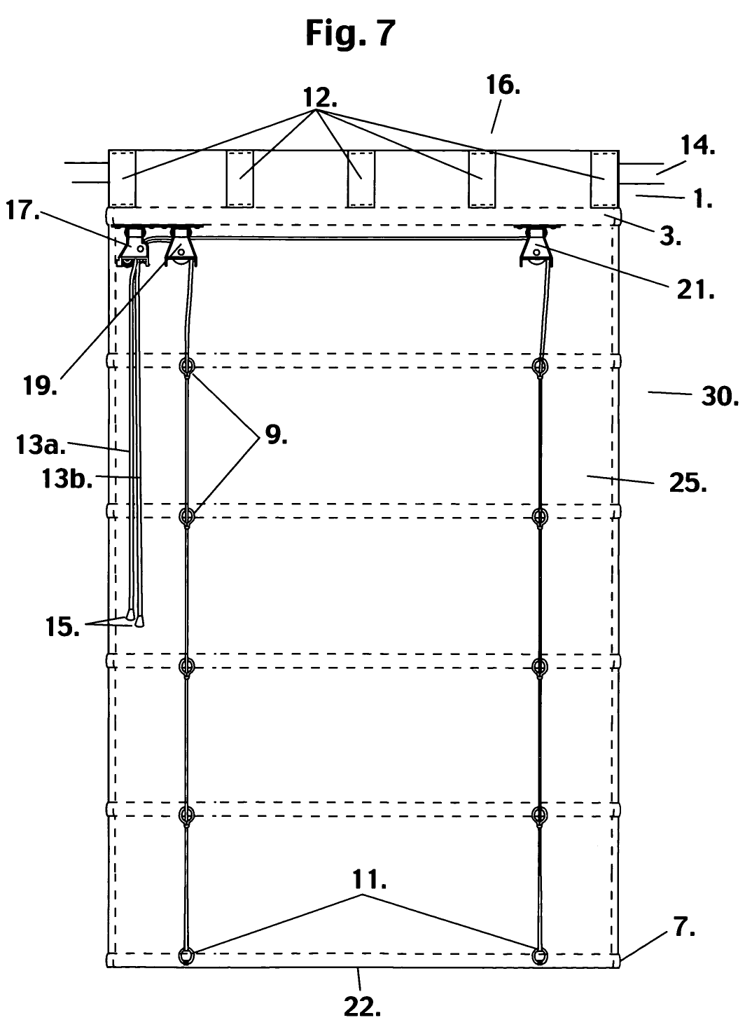

The rod receiving sleeve (1) may include, but is not limited to, a tab top configuration (12), or any other suitable configuration such as, for example a continuous sleeve extending along at or near the top of the panel (33), a broken rod sleeve configuration (32) or a tabbed back configuration (16) where tabbed sleeves are affixed to a continuous piece of material along at or near the top of the panel, as shown in FIG. 7. In FIG. 1, sleeve (1) is a single continuous fabric extending continuously along the top (2) of panel (25). In an alternative embodiment, sleeve (1) may extend at least substantially continuously along the top side (2) of window treatment (25). In one embodiment, the present invention has a single continuous rod sleeve (33) positioned at the top (2) of the panel (25), wherein the continuous rod sleeve (33) extends across at least a substantial portion of the width of the window treatment (25). Preferably, the continuous rod sleeve (33) extends across substantially the entire width of the panel (25).

In one embodiment, sleeve (1) is positioned along the top portion (2) of panel (25). The sleeve may comprise any material shaped in such a way such that a rod may be passed therethrough, including, but not limited to, a piece of fabric folded to form a sleeve. Such piece being secured at one or more edges with one or more stitches, buttons, staples, Velcro, glue, a piece of wrapped material, a tab of fabric, snaps, grommets, rivets, zippers, tape, a piece of molded plastic, or a piece of molded or carved wood, for example. In one alternative embodiment, sleeve (1) may be affixed to the backside, front side or top of the window treatment. The backside is the side of the window treatment that faces the window when suspended. The front side is the side of the window treatment that faces the room.

Sleeve (1) is sized to accommodate any standard rod which provides support for hanging window treatment (25). In one embodiment, sleeve (1) accommodates a rod having a diameter of about 0.1 inches to about eight inches, or preferably about 0.5 inches to about 5 inches, or even more preferably about 3 to 4 inches, even more preferably 0.25 to about 2 inches. In another embodiment, the diameter of sleeve (1) may be from about 1 inch to 12 inches, preferably 2 inches to 5 inches, more preferably about 3 inches in diameter. In one embodiment, each of sleeve (10) may be about from about 0.1 inches to about 10 feet long in length, or from about one inch to about four feet long in length, or from about six inches to about 12 inches in length.

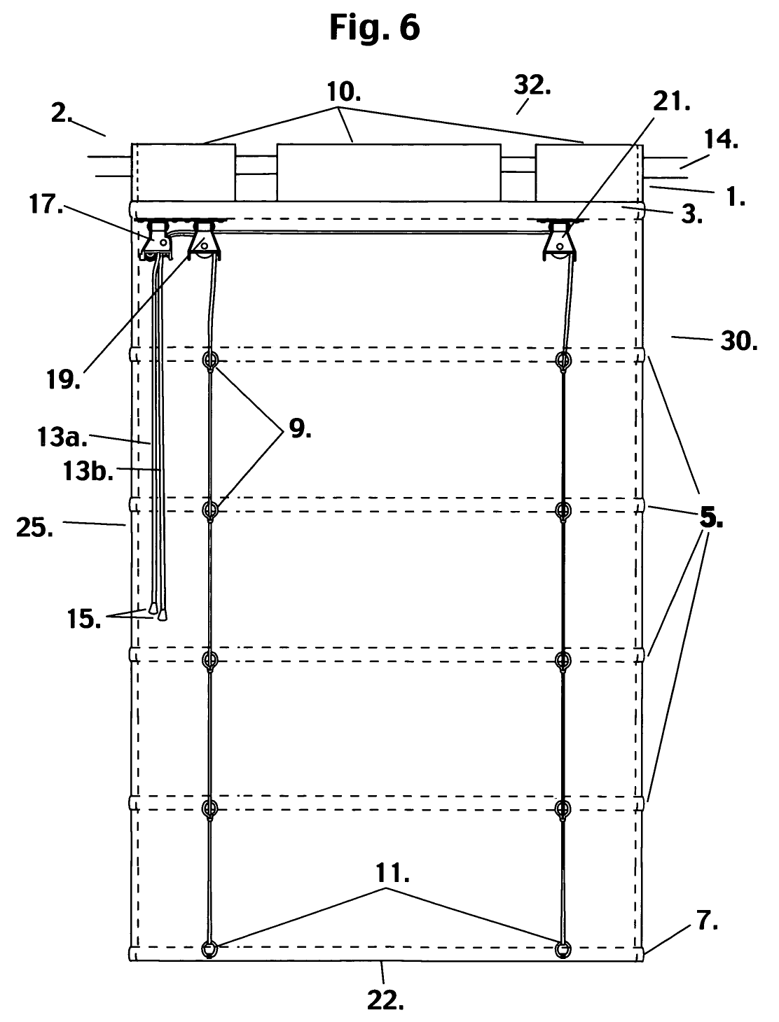

In another alternative embodiment, the sleeve may comprise two or more separate sections suitable for securing a rod, whereby the panel can be suspended in front of a window, for example, by inserting the rod through the two or more sections. In one embodiment, in reference to FIG. 6, sleeves (10) are suitable for securing a rod. Sleeves (10) being affixed to the top (2) of panel (25). When inserted through sleeves (10), the rod is parallel to side (2). Sleeves (10) are sized to accommodate any size rod which provides support for hanging the window treatment.

In another embodiment, in reference to FIG. 7, a series of sleeves of the shape of tabs (12) are positioned on the backside of panel (25). Tabs (12) are suitable for receiving a rod therethrough. In one embodiment, each of tabs (12) has a top edge and a bottom. Each of tabs (12) is affixed to the backside of the panel at or near the top (2) of the panel. Tabs (12) may be affixed to the top of the panel by securing the top and the bottom of each tab via stitches that extends continuously along the top of the panel, forming a tab-backed sleeve (16). In an alternative embodiment, the one or more tabs may be affixed to panel (25) with buttons, staples, snaps, glue, or any other securing means described herein.

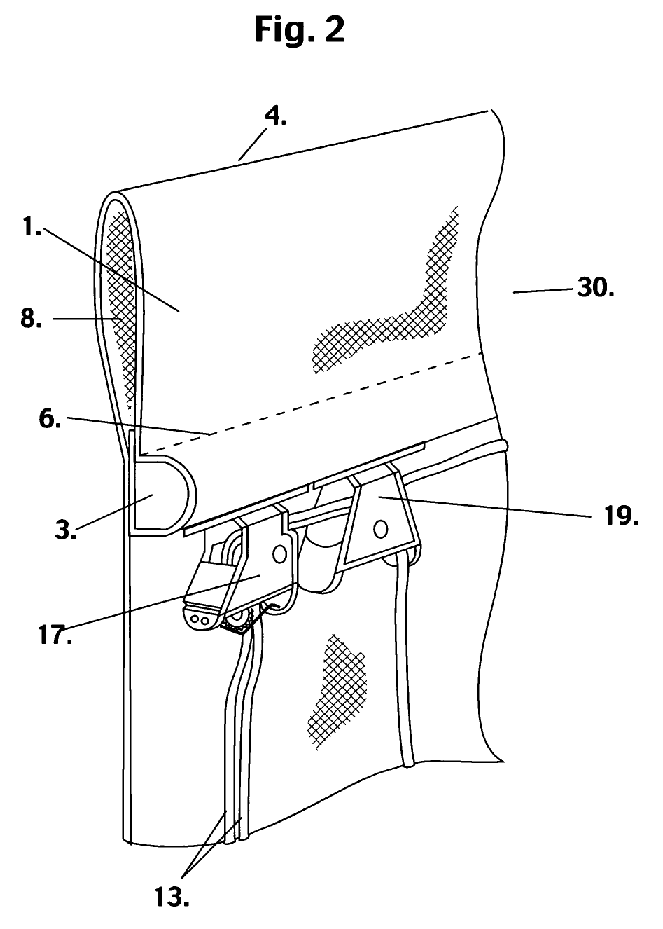

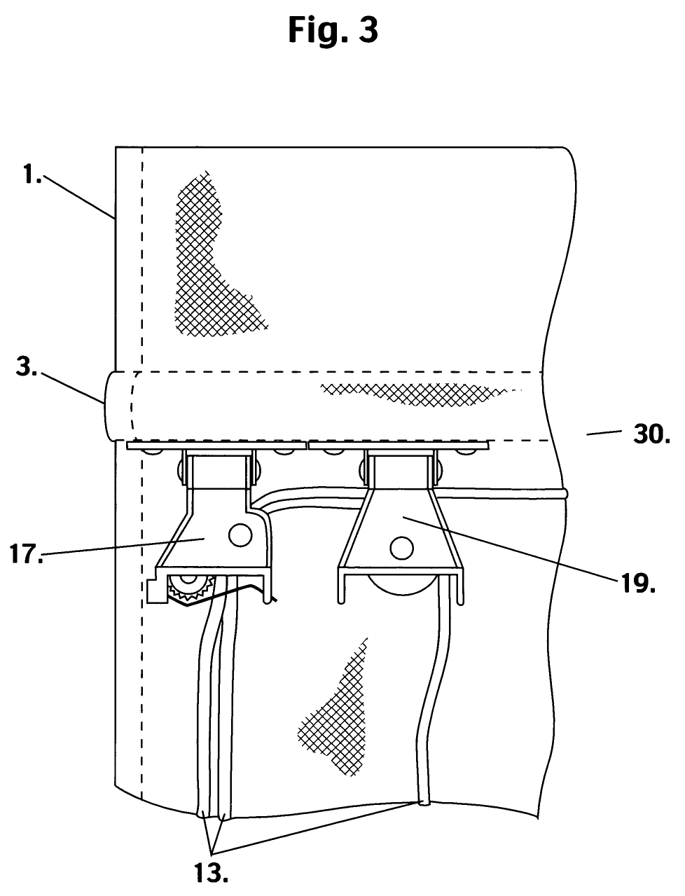

In an embodiment of the present invention, in reference to FIG. 2, sleeve (1) may be constructed by extending (23) above top (2), folding flexible panel (23) so as to create fold (4), wrapping panel (23) around top support bar (3) and securing the panel (23) using stitches (6). FIG. 3 shows the top left corner of sleeve (1). In alternative embodiment, sleeve (10) is secured using, for example, glue, staples, buttons, snaps, Velcro, tacks, or any other securing means described herein. Sleeve (1) having an interior (8) though which a rod may be inserted. In an alternative embodiment, sleeve (1) is separate from panel (25) and is affixed to window treatment (25) using stitches, glue, staples, buttons, snaps, Velcro, tacks, or any other securing means described herein. The sleeve may comprise any of the fabrics or materials described herein. The sleeve may comprise different fabric or material than that of the rest of the panel. The sleeve may be a separate component or integrated with the panel so as to form one unit.

Separate and distinct from rod sleeves, other materials for suspending the panel from a rod can be used. Such materials include, but are not limited to, rings, straps, or loops. In one embodiment, one or more rings, strips, or loops may be positioned near or at the top of the panel. Here, a rod may be inserted through the rings, strips, or loops may to suspend the panel (25). The openings of the rings may be sufficient to fit rods from about 0.1 inches to about 5 inches in diameter, preferably from about 1 to 3 inches in diameter. In one embodiment, the rings, strips, or loops may fit rods up to about 1⅜ inches in diameter.

In another alternative embodiment, the window treatment of the rod sleeve has two or more sections positioned across the top (2) of the window treatment. Preferably, two or more sections of fabric may be of equal length and/or spaced at equal distances. In another alternative embodiment, the present invention has one or more tabs (12) suitable for suspending the panel (25) on a rod (14). Preferably, the tabs (12) are of equal size and are spaced at equal distances along the width of the shade.

In an alternative embodiment, the sleeve may comprise two or more materials suitable for securing a rod, wherein the two or more materials are of equal length, such that when suspended the weight of the shade is evenly distributed along the rod. In another embodiment, sections of the sleeves are spaced equidistantly apart along the width of the shade. In one embodiment, a marginal portion of the top of the panel is sewn to the main body of the panel along parallel lines to define the rod receiving sleeve and a top hem.

In another embodiment, a supporting rod may be received through the rod sleeve (1) at the top (2) of the panel (25) and is positioned within the window frame opening or outside the window frame opening, thus covering the window or window frame completely. This gives the user greater flexibility in installing the panel. Additionally, the panel of the present invention can accommodate a variety of window drops, thus eliminating the need to have the panel custom-made, which can be costly and time-consuming. In an alternative embodiment, the panel is installed over at least a portion of a door, porthole, wall, ceiling, walkway window, mirror and the like. In one embodiment, the panel is installed over the top of a door, porthole, wall, ceiling, walkway, window, mirror and the like.

4. Slats

The raisable panel of the present inventions may comprise a plurality of horizontally extending vertically spaced slats (5) positioned along the panel. In one embodiment, the slats may be positioned along the front side (29) or back side (30) of the panel (23). In one embodiment, the slats (5) may also be positioned between each side. In another embodiment, the slats may be positioned between two fabrics sewn together. Here, the slats may be sewn between two materials wherein at least one of the materials is completely lined, partially lined or not lined at all. The slat may also be positioned within a pouch or sleeve formed by adjoining two portions of the same side of the panel. In another embodiment, the slats (5) may be substantially parallel to the top of the panel. The slats (5) may comprise a cylindrical structure or narrow strip. The slate may comprise metal, plastic, wood or other types of material or construction. In one embodiment, the slat may comprise a dowel. In one embodiment, the present invention comprises 2 to 10 slats, 2 to 8 slats, 2 to 6 slats, preferably 4 to 6 slats, most preferably 4 slats. In one embodiment, the slats may prevent the panel from ballooning or swaging when raised. The slats may also prevent formation of folds or bends like an accordion, or it may prevent unsightly wrinkles. In one embodiment, the panel may have a swag when raised, if such an appearance is desired. Otherwise, the present panel may be configured to produce no swag when raised.

In one embodiment, the raisable panel of the present invention may comprise no slats. For example, the panel may comprise material sufficiently firm, thick or heavy (for example) to maintain folds when in a raised position. Such materials include, but are not limited to, heavy cotton, tapestry, fabric having supports integrated therein, bamboo, canvas with bamboo woven therein or fabrics coated with material that enables the fabric to maintain folds when in a raised position.

5. Top and Bottom Support Element

The present panel may comprise a top support element (3) positioned at or near the top of the panel (25). In one embodiment, the top element may support the hardware for operating the panel or it may be used to support the rod sleeve. The present panel may also comprise a bottom support element (7) positioned at or near the bottom of the panel (25). In one embodiment, the bottom element (7) may be of sufficient weight to prevent the panel from ballooning or swaging when fully open. The bottom element may also prevent formation of unsightly wrinkles or accordion like folds. The top support element or bottom support element may comprise various materials, including, but not limited to metal, plastic, wood, bamboo or stuffed fabric. In one embodiment, the top element or bottom element may comprise a cylindrical structure, narrow strip, or any other suitable configuration to produce a desired look.

6. No Need for Collateral Hardware (Installation)

Conventional installation of raisable panels (e.g., window treatments) requires the use of tools and hardware. Such installation can be awkward, time-consuming and damaging to frames. It is also difficult to remove window coverings installed by traditional means. If the window treatment cannot be uninstalled or is damaged in the process, then it cannot be used again.

The present panel may be easily installed on or uninstalled from a rod (e.g., conventional curtain rod) without the need of collateral hardware or special tools typically used for installing raisable panels. In one embodiment, the present panel easily slides onto any conventional rod already in place. As used herein, the term “collateral hardware” refers to items ordinarily used to install prior art raisable panels, but is not required to install the present invention on a rod. Items not required to install the present invention include, but are not limited to, back plates, hooks, wall fasteners, loop fasteners, screw eyes, mounting brackets, mounting boards, clamps, latching mechanism or any customized or specialty item for installing a window treatment.

For instance, raisable panels of the present invention can be suspended without attaching them directly to a mounting board using collateral hardware, and then attaching the board to the inside or outside of a window frame using more collateral hardware. In one preferred embodiment, the panel of the present invention may be installed by sliding it onto any conventional curtain rod without the use of collateral hardware.

In another embodiment, the raisable panel of the present invention is suspended on a traditional rod that was already installed for another panel. Here, the present invention may easily be slid onto any rod. Thus, there is no need to attach the present panel directly to a mounting board using hardware, and to mount the board to the inside of the window frame. Ordinarily, the installation hardware for one window treatment is not suitable for another window treatment. However, the present invention can be installed and suspended from any previously installed rod customarily used for other types of window treatments. Further, the present invention can be installed on either the inside, or the outside, of a window or door frame without the use of collateral hardware. Thus, the present invention provides the user with greater flexibility in installation.

In one embodiment, the panel of the present invention is not dependent upon the size of the opening (e.g. window frame or window). Consequently, the present invention can accommodate a plurality of drops, sizes and/or shapes when suspended over (or at least partially over) a door, window porthole, wall, ceiling walkway, mirror and the like. In another embodiment, the present invention accommodates more than one window size when installed outside the window frame. At the same time, the present invention retains its aesthetic appearance when raised.

7. Raising and Lowering Means for Raising the Panel

The panel of the present invention comprises means for raising or lowering the panel to a desired position. In one embodiment, the present invention comprises a plurality of rows of vertically spaced guide elements (e.g., rings) (9) on one side of the panel (23), preferably the back side (30). The guide elements (9) may comprise wooden, metallic, or non-metallic material (e.g., plastic). The guide elements may be secured to the panel (23) by conventional means. In one embodiment, the guide elements (9) may be fixed in place by stitching them to the surface (24) of the panel (25) or affixing them to the slats (5).

Multiple pull cords (13) may be attached at or near the bottom (22) of the panel (23) at laterally spaced locations corresponding to the row of guide elements (9). Individual pull cords may pass through one row of vertically spaced guide elements (9) from the bottom (22) of the panel (23) to the uppermost guide element (9). In one embodiment, the pull cords (13 may then extend laterally along at or near the top (2) of the panel (23).

In one embodiment, each pull cord (13) is guided or threaded through one vertical row of guide elements (9) and one extremity of the pull cord is attached to the lowermost guide element. Above the uppermost guide element of each row, each pull cord (13) may be extended laterally, all in the same direction, to one side edge of the window treatment where the plurality of pull cords (13) are grouped and permitted to depend downwardly. The free extremities may be united into a convenient grasping element.

In one embodiment, vertically extending pull cords (13a/13b) pass upwardly through the guide elements (9) attached to the backside (30) of the panel (25). The cords pass (13) through the pulleys (19 and 21) at the top (2) of the panel (25) and the ends of the cords (13) are allowed to hang down. These cords may be gathered together at their free end to be grasped by the user for raising and lowering the panel (25). Here, pulleys (13a/13b) can perform the conventional function of changing the direction of tensile load bearing elements in the form of cords or strings. The pulley may also perform a control function of holding cords and preventing them from moving under the influence of gravity. The present invention may also comprise a self-locking mechanism (17). In one embodiment, the present panel (25) may comprise two or more cords (13) spaced horizontally across the width of the panel. In another embodiment, the present panel may comprise 2 cords, 3 cords, 4 cords, 5 cords or 6 cords spaced horizontally across the width of the panel.

In one embodiment, the panel comprises means for selectively holding the bottom of the fabric in a desired position. For example, the window treatment may be raised by pull cords which are tied or otherwise secured to the bottom of the panel to the window treatment in a raised position, thereby concealing the cords behind the panel. In another embodiment, the window treatment can be maintained in a desired raised position by a locking mechanism (17). The cords may then be secured by a securing means. In one embodiment, the securing means is a slip tab positioned at or near the bottom edge of the panel. Such tab may comprise an elongated flexible piece of material having an attaching means on both ends. The attaching means can be any securing means described herein. The ends of the slip tab may be removably attached to each other, forming an opening whereby the cords may be wrapped or otherwise secured thereto behind the panel. This reduces the strangulation hazard of the pull cords.

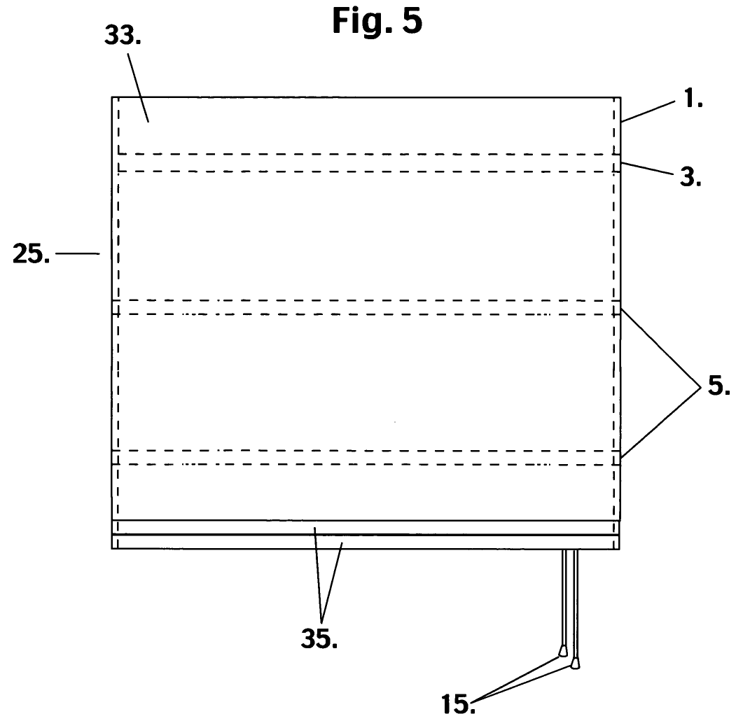

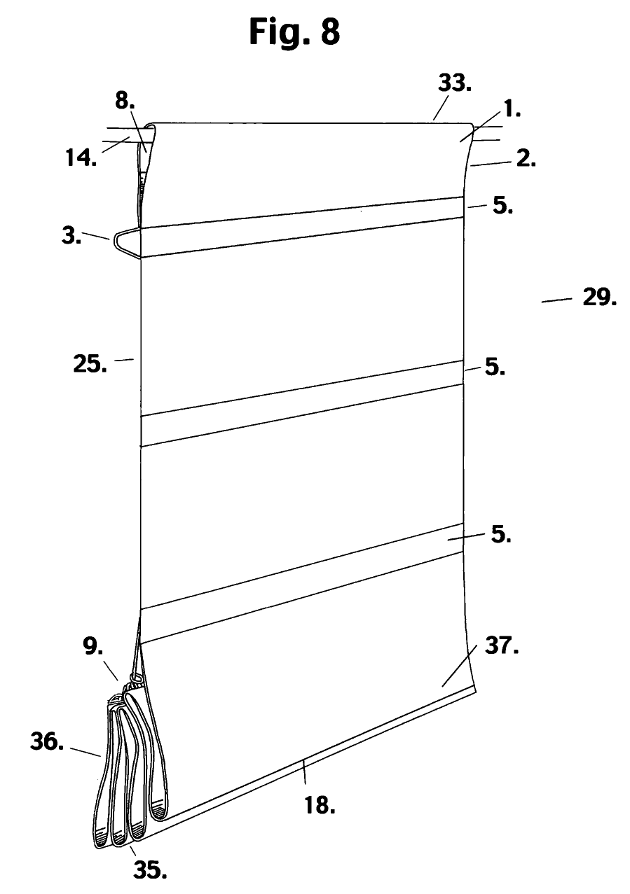

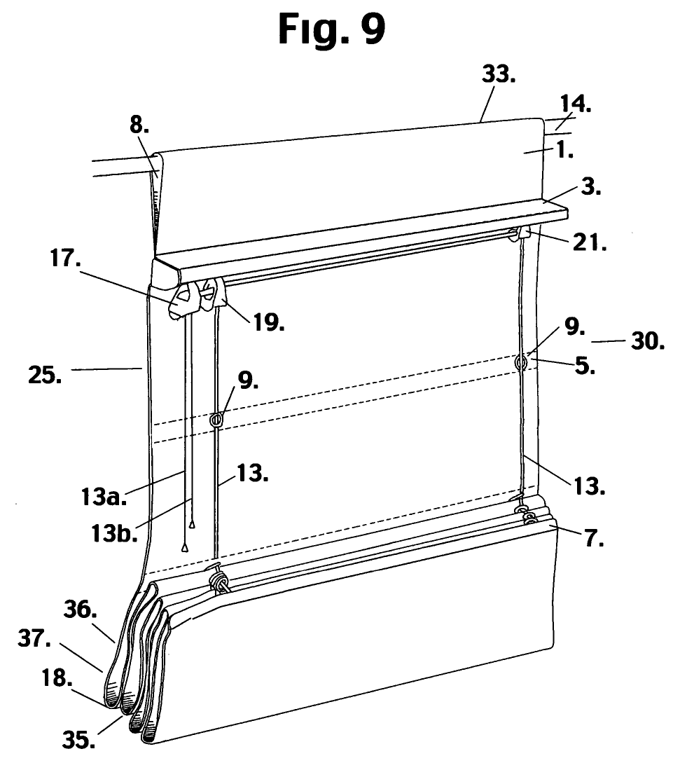

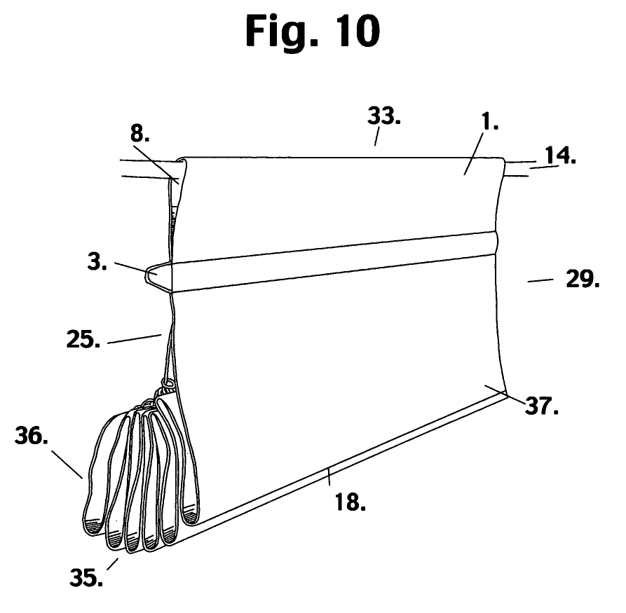

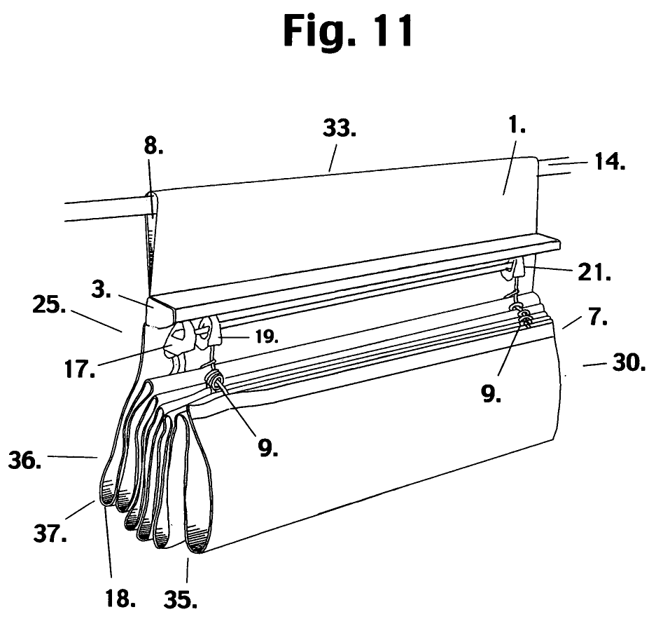

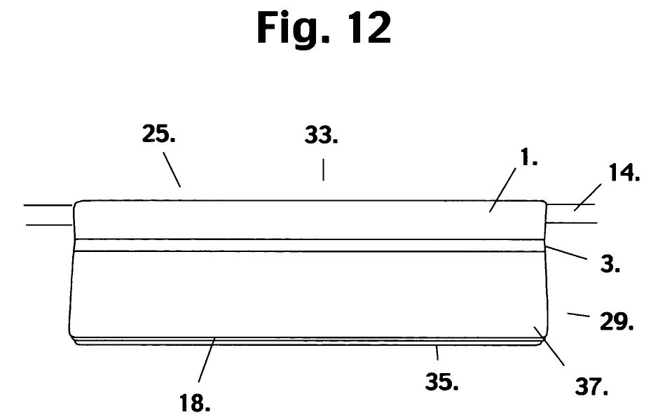

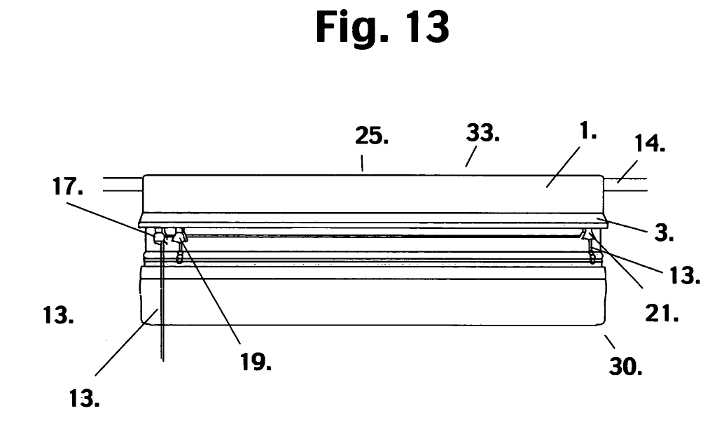

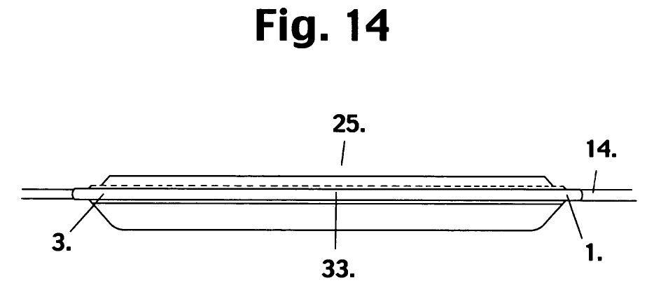

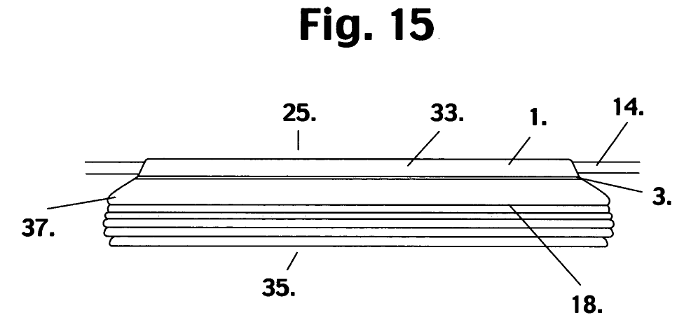

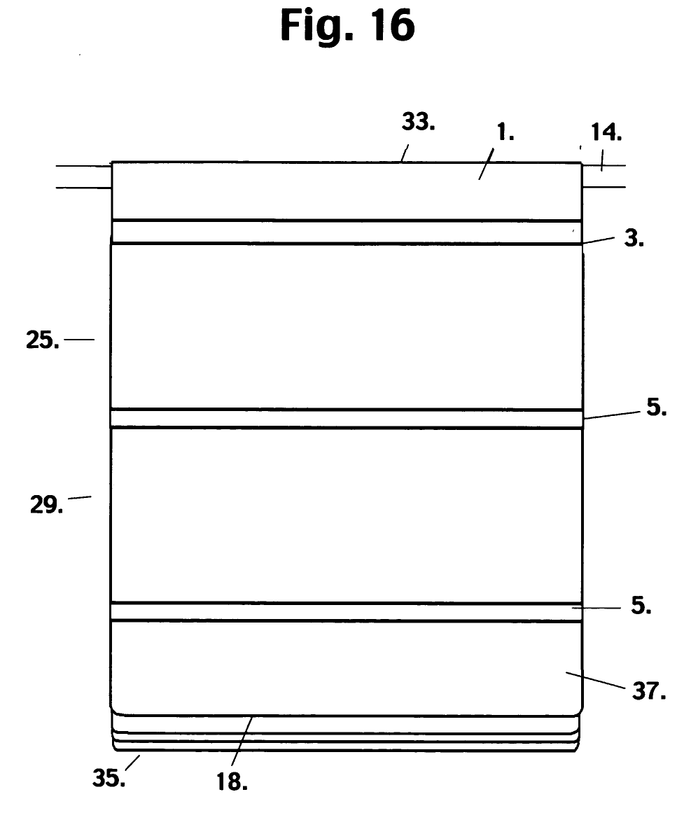

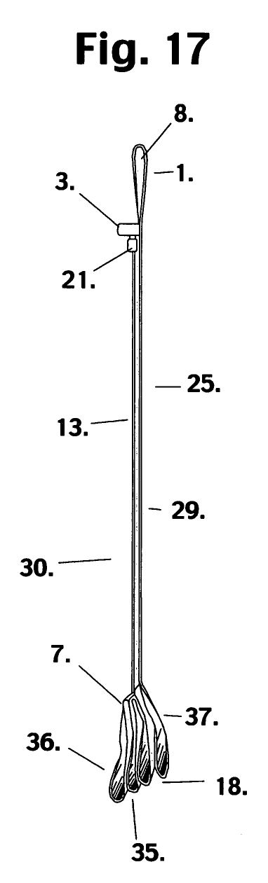

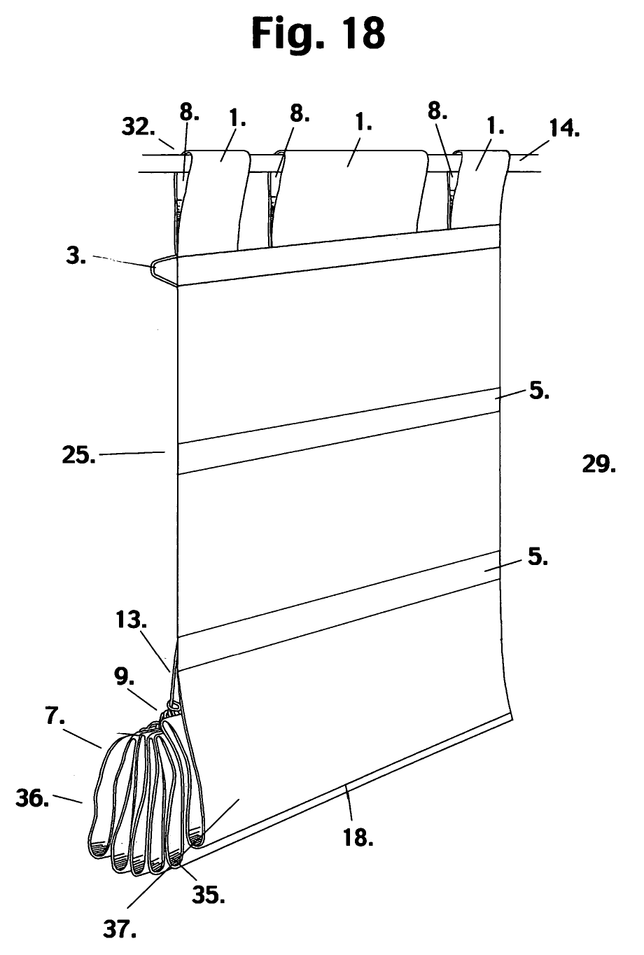

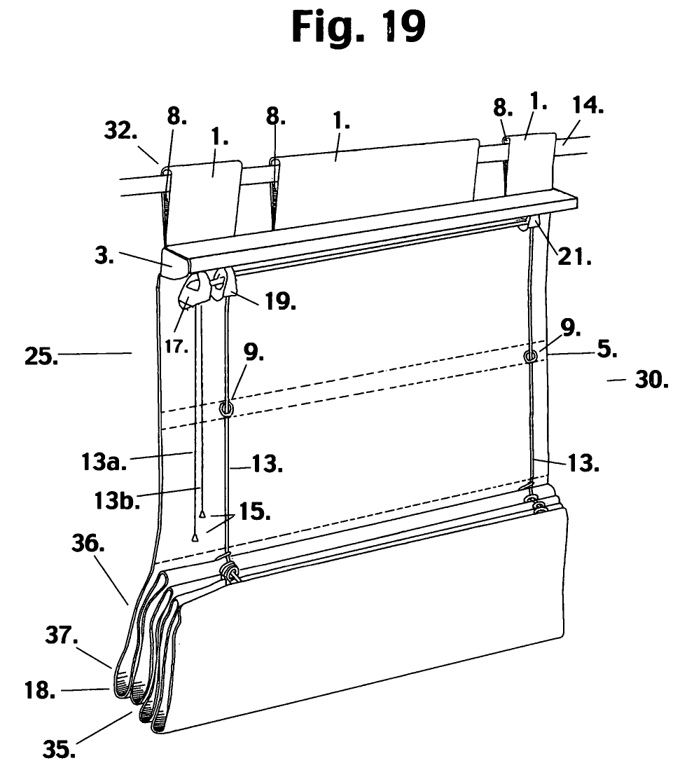

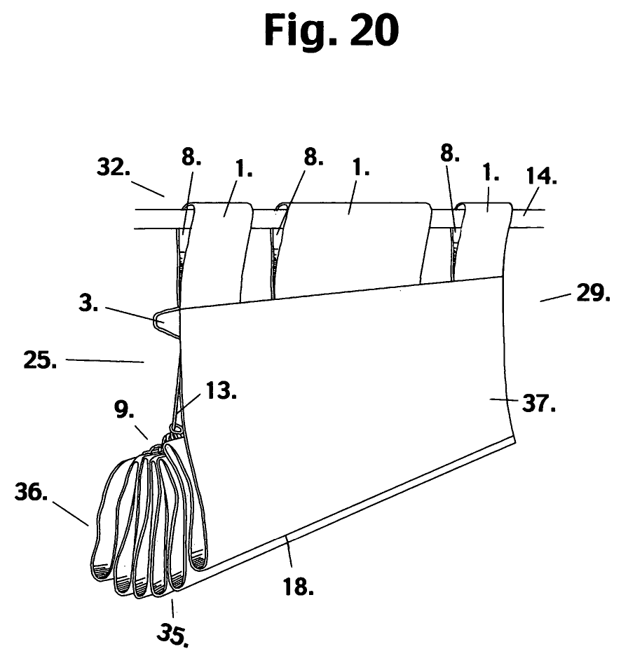

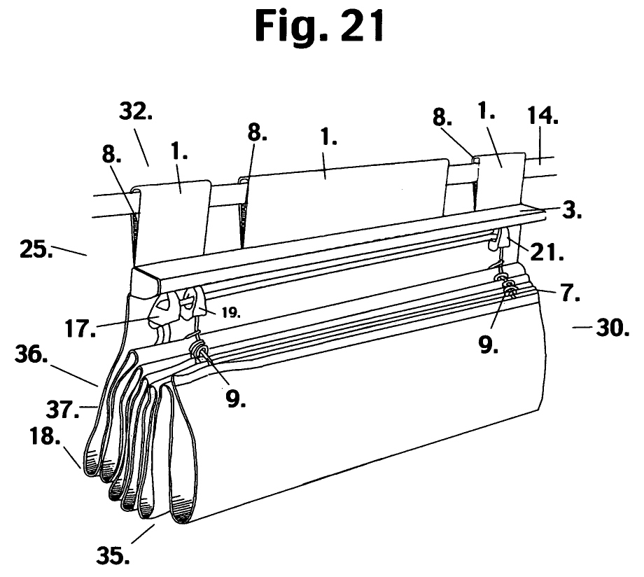

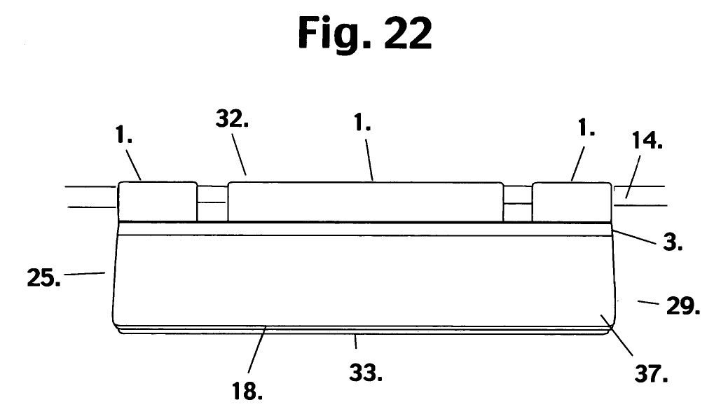

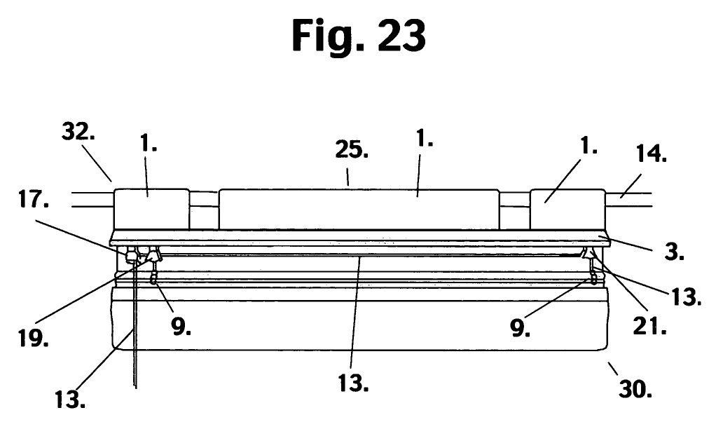

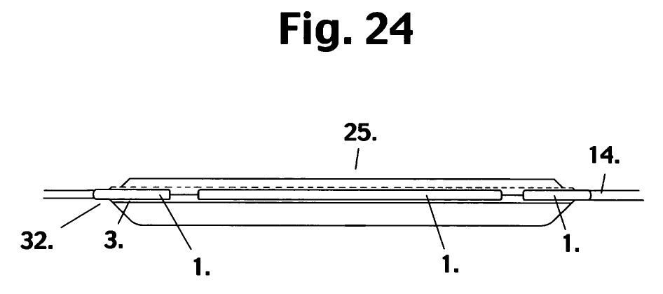

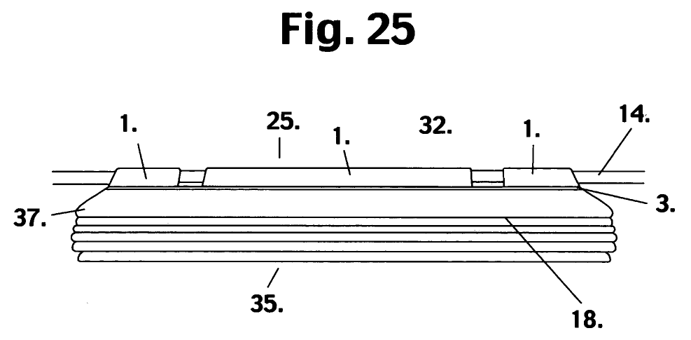

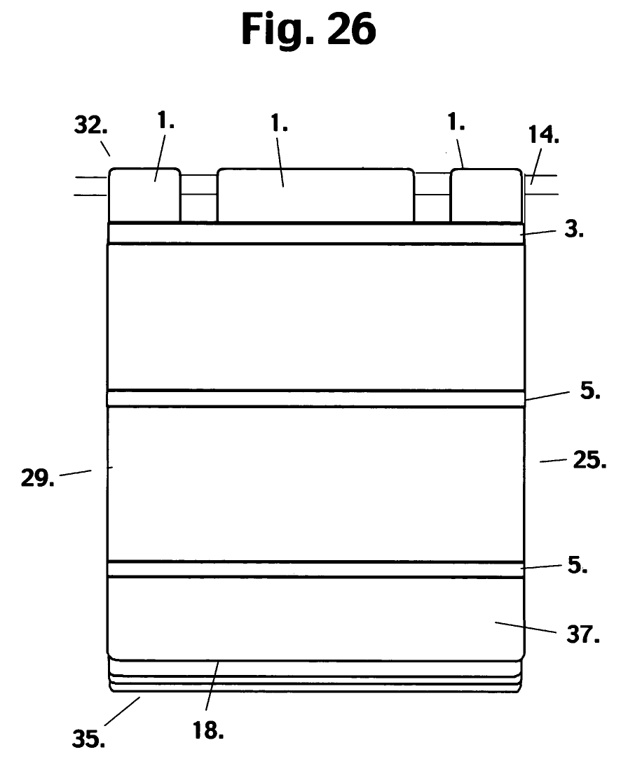

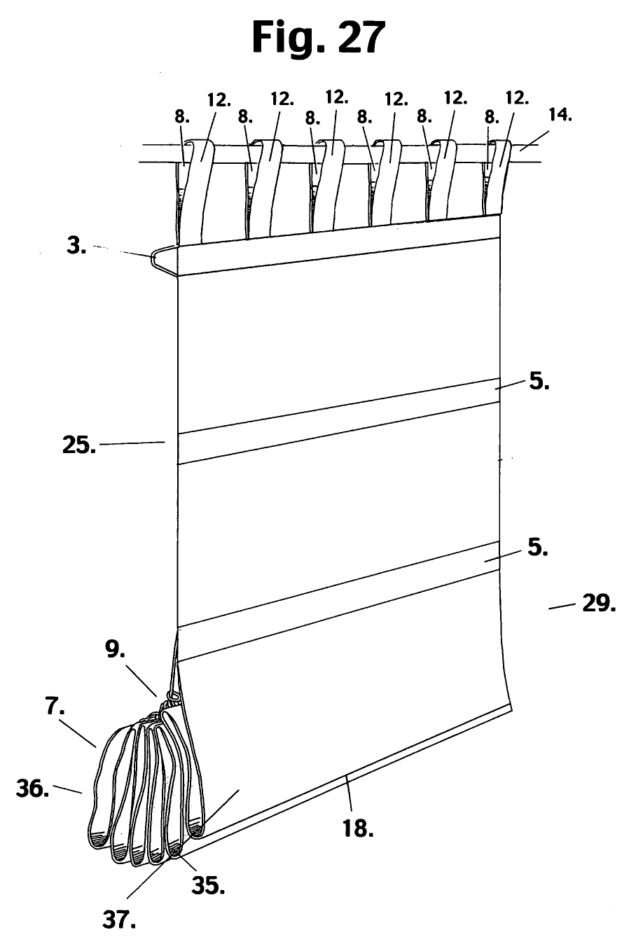

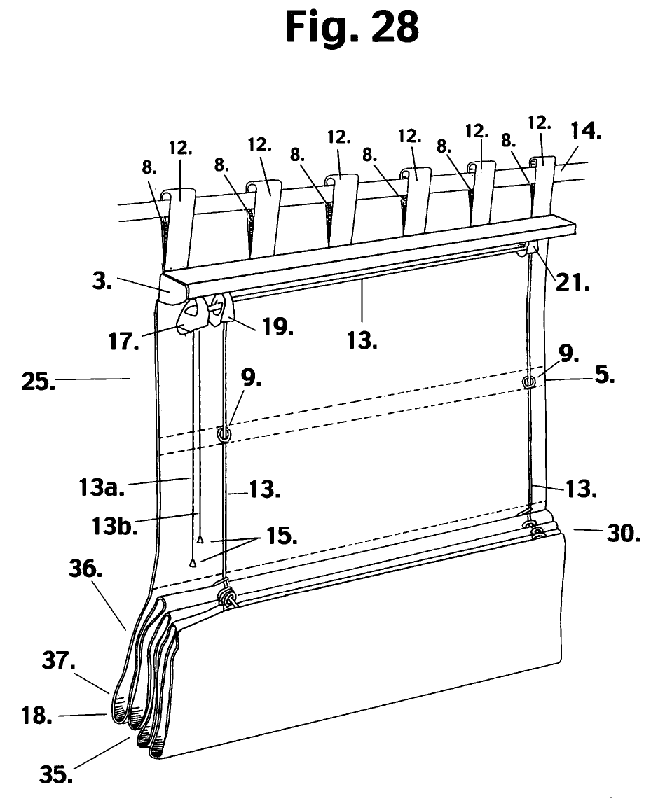

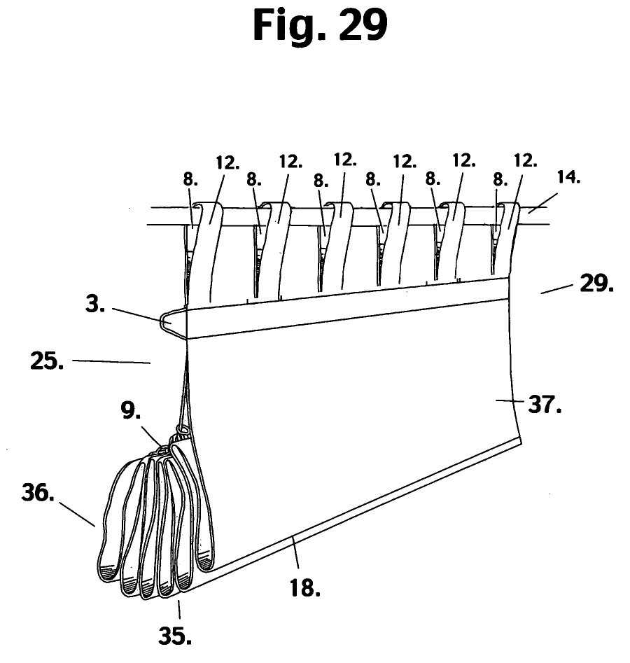

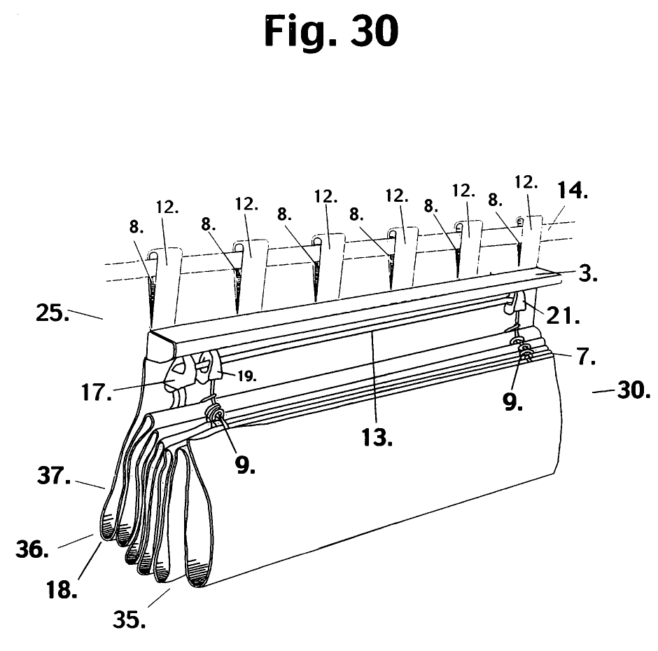

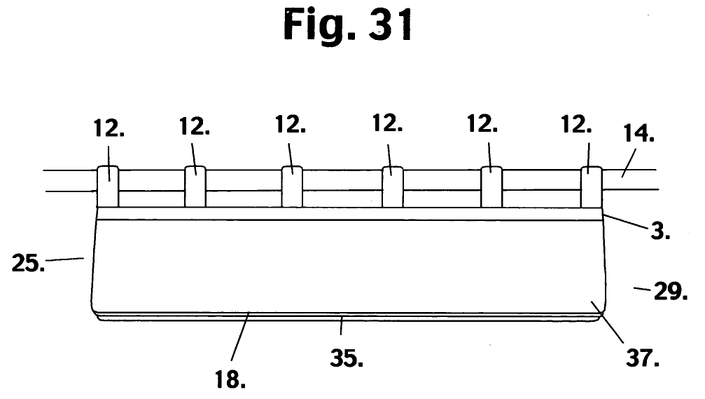

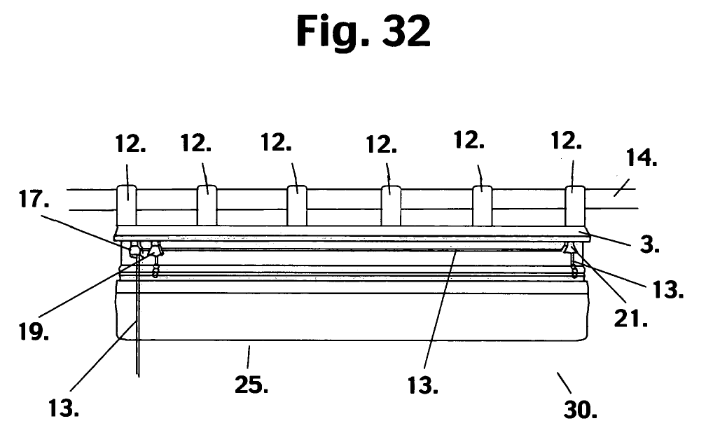

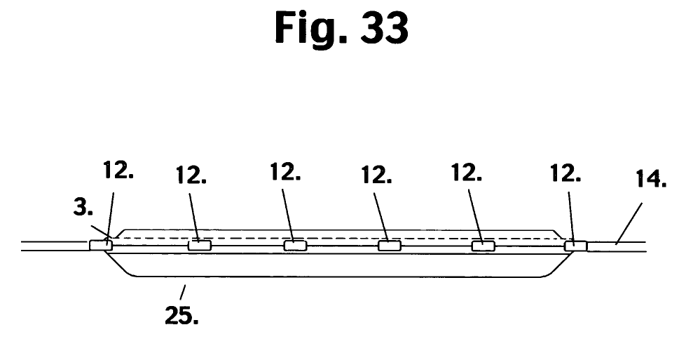

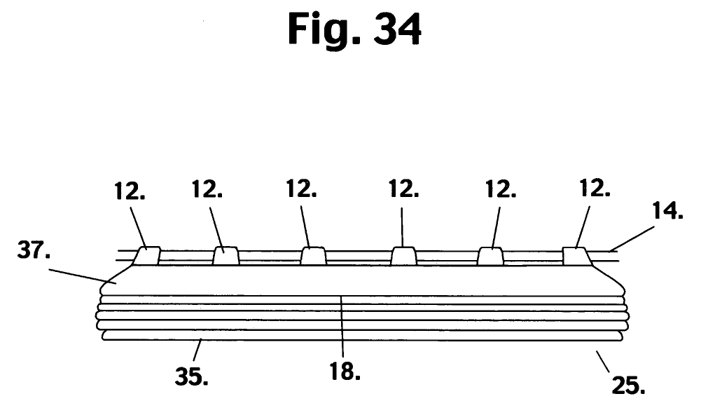

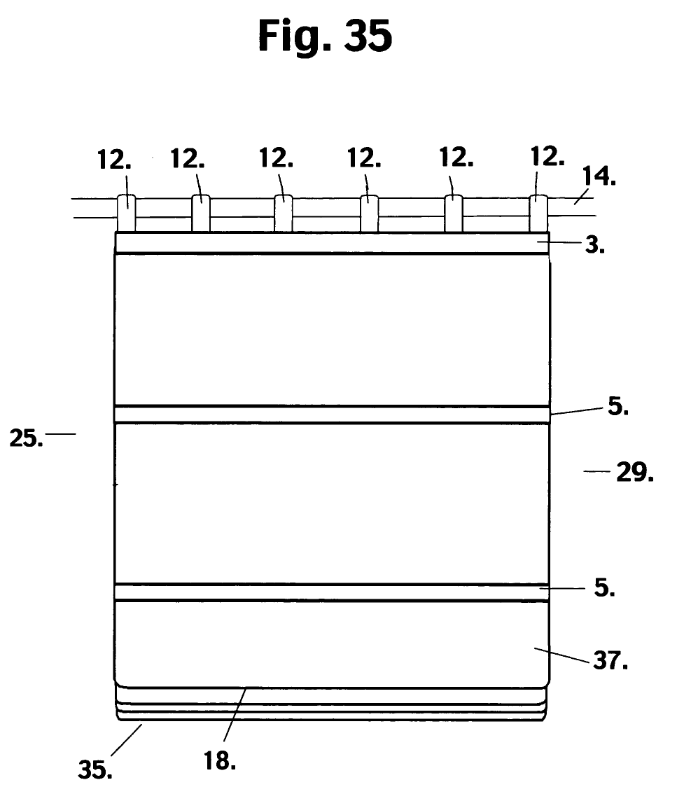

In one embodiment, the window treatment entails simultaneously pulling the pull cords (13) in an appropriate direction thereby exerting lifting force upon the lowermost guide element (9) and elevating the window treatment (25) from the position of FIGS. 1, 6, 7, toward that of FIGS. 5 and 8-35. For example, in another embodiment, the pull cords may be concealed at the back of the window treatment and only appear at one side of the window treatment as a single array of pull cords.

In reference to FIG. 1, a view of the backside of one embodiment of the present invention is shown. In FIG. 1, raisable panel (25) comprises sleeve (1), top support bar (3) and a bottom support bar (7). Panel (25) further having slats (5). Vertically extending cords (13a) and (13b) pass through bottom guide elements (11) upwardly through guide elements (9) towards top portion (2). Guide elements (11) and (9) serve as guides for cords (13a) and (13b). Cord (13a) passes through first and second pulley (19) and (21), respectively. Cord (13b) passes through pulley (19). Both cords (13a) and (13b) pass through locking pulley (17) and then hang down freely. Locking mechanism (17) including any conventional locking means suitable for use herein. The user raises and lowers window treatment (25) by pulling on cord ends (15). In another alternative embodiment, the window treatment comprises two, three or five cords for raising and lowering the panel.

8. Appearance of Panel when Raised

When drawn the present panel forms a series of predetermined horizontally stacking pleats (35) without ballooning, swaging or folding like accordion. In one embodiment, the one or more of the horizontally stacking pleats may be non-ballooning, yet still have a swag. In another embodiment, the horizontally stacking pleats exhibit no swag and ballooning.

In one embodiment, when the panel is raised, the stacking pleats (35) gather in a lateral direction on the back side (30) of the panel (25). The stacking pleats (35) may have longitudinally extending folds (36). These extending folds (36) may resemble a series of elongated tear drops, or they may comprise an elliptical, ellipsoidal, or obround configuration, when viewed from the side.

In another embodiment, when the pull cords (13) are pulled downward, the bottom support element (7) is elevated. Such elevation causes the panel (25) to fold upon itself. This, in turn, causes the formation of a series of predetermined horizontally staking pleats (35) which gather in a lateral direction on the backside (30) of the panel (25). The stacking pleats may also form longitudinally extending folds (36). In one embodiment, the bottom of the stacking pleats (36) remain substantially even with the bottom edge (18) of the front side (29) of the panel (25). In one embodiment, the bottom support element (3) is positioned at an outermost lateral position when the panel (25) is raised. In another embodiment, the bottom support element (7) may facilitate maintaining the configuration of the overlapping pleats.

In yet another embodiment, when the panel (25) is raised, the stacking pleats (35) may be disposed one behind the other so that only the front pleat (37) is visible from the room when the panel is fully drawn or partially drawn. In another embodiment, when raised, the stacking pleats disposed behind the front-most pleat are visible. In one embodiment, the one or more pleats behind the front most pleat may be 2 to 4 inches lower, or 0.5, 1, 1.5, 2, 2.5, or 3.5 inches lower when the panel is raised. In yet another embodiment, the edges of the pleats are at least substantially even with each other when the panel is fully drawn or partially drawn.

In an embodiment of the present invention, in reference to FIG. 5 (for example), panel (25) may have a smooth, pleated appearance when suspended. FIG. 5 shows a front side view of a panel of the present invention partially raised and folds of fabric (35).

In one alternative embodiment, the present invention is directed to a raisable panel (25) suspendable from a curtain rod (14) over at least a portion of a window. When raised, the panel is substantially free of ballooning or swaging. The panel (25) may comprise a horizontally extending top (27) and a horizontally extending bottom (28). The panel (25) also comprises a front side (29) and a back side (30). In another embodiment, the present invention comprises a plurality of horizontally extending vertically spaced slats (5) positioned along the panel (25). The slats (5) may be substantially parallel to the top (2) of the panel (25). In one embodiment, the slats may define a plurality of horizontally extending vertically spaced fold lines to form horizontally stacking pleats (35) when the panel is raised. Here, the length of the stacking pleats (35) may be substantially parallel to the top (2) of the panel (25). In one embodiment, a horizontally extending top support bar (3) is positioned at or near the top (2) of the panel (25). The present panel (25) may also have a horizontally extending bottom support bar positioned (7) at or near the bottom (22) of the panel (23).

The present panel (25) may also comprises a sleeve (1) for receiving the rod (14) to install and suspend the panel (25). The sleeve may extend laterally along the top (2) of the panel (23) to enable insertion of the rod (25) through the sleeve (1) for installation of the panel (25). The installation of the panel (25) is completed without collateral hardware.

The present panel may also comprise a plurality of rows of vertically spaced guide elements (9) on the back side (30) of the panel (23). In one embodiment, the guide element may define vertically spaced fold lines to form predetermined horizontally stacking pleats when the panel is raised. In one embodiment, the length of pleats are substantially parallel to the top of the panel. Multiple pull cords may be attached to the bottom (22) of the panel (23) at laterally spaced locations corresponding to the row of guide elements (9). Each pull cord (13) may pass through one row of vertically spaced guide elements (9) from the bottom (22) of the panel (23) to the uppermost guide element (9), and then extend laterally along at or near of the top (2) of the panel (23).

In one embodiment, when the pull cord (13) is pulled downward, the bottom support element (7) is elevated, thereby causing the panel to fold upon itself laterally along fold lines defined by the guide elements (9) or slats (5), thereby forming a series of predetermined horizontally stacking pleats (35) without substantially ballooning or swaging when raised. The stacking pleats (25) may gather in a lateral direction on the back side (30) of the panel (23). In another embodiment, the stacking pleats (35) form longitudinally extending folds (36). The stacking pleats (36) can be substantially even or slightly lower than the bottom edge (18) of the front side (29) of the panel (23). The bottom support element (7) may be positioned at an outermost most lateral position when the window treatment (25) is raised. In one embodiment, the slats (5) may prevent the stacking pleats from ballooning or swaging when the window treatment is raised. In another embodiment, the present invention, when raised, produces no folds or bends resembling an accordion, nor does it produce unsightly wrinkles.

The raisable panels described herein can be made using techniques known to those of ordinary skill in the art. The embodiments described herein are representative of raisable panels that can be hung from a conventional rod, but may have the same appearance as custom made window treatments nailed to a board, for example. Additionally, although a one-piece construction has been illustrated, it will be appreciated that the window treatment may be made from two or more pieces comprising different fabrics or materials, if so desired.

Although particular embodiments of this invention have been described and illustrated herein, the present invention can be further modified within the scope and spirit of this disclosure. This application is therefore intended to cover any variations, uses, or adaptations of the invention using its general principles. Further, this application is intended to cover such departures from the present disclosure as to come within known or customary practices in the art to which this invention pertains and which fall within the limits of the appended claims.

Throughout the description, where the present invention is described as having, including, or comprising specific components, it is contemplated that the present invention also consists essentially of, or consists of, the recited components. Also, one or more elements may be omitted from the claimed invention, or the invention described herein suitably may be practiced in the absence of any component or step which is or is not specifically disclosed herein, so long as the invention remains operable.

Further, the present invention may be embodied in other forms without departing from the spirit or essential characteristics thereof. The foregoing embodiments and figures are therefore to be considered illustrative rather than limiting the invention described herein. Moreover, the foregoing description of a preferred embodiment of the invention has been presented for purposes of illustration and description. It is not intended to be exhaustive or to limit the invention precise form disclosed.

The content of each patent and non-patent document referred to herein is expressly incorporated herein by reference in its entirety.

What is claimed is:

1. A raisable panel suspendable from a rod, when raised the panel is free of ballooning, the panel comprising:
(i) a horizontally extending top and a horizontally extending bottom;
(ii) a front side and a back side;
(iii) a plurality of horizontally extending vertically spaced slats; the slats are positioned along the panel, the slats are substantially parallel with the top of the panel;
(iv) a sleeve positioned at or near the top of the panel to enable insertion of the rod through the sleeve for installing and suspending the panel; the sleeve is adapted to enable the installation to be completed without collateral hardware;
(v) a plurality of rows of vertically spaced guide elements on the back side of the panel, multiple pull cords secured at or near the bottom of the panel at laterally spaced locations corresponding to the row of guide elements, each pull cord passing through one row of vertically spaced guide elements from the bottom of the panel to the uppermost guide element, and then extending laterally along at or near a top of the panel; the guide elements defining vertically spaced fold lines to form predetermined horizontally stacking pleats when the panel is raised, wherein the length of the pleats are substantially parallel to the top of the panel; and
(vi) when the pull cord is pulled down, thereby causing the panel folds upon itself laterally along the fold lines defined by the guide elements, thereby forming a series of predetermined horizontally stacking pleats free of ballooning; the pleats gathering in a lateral direction on the back side of the panel, the overlapping pleats forming longitudinally extending folds.

2. The panel of claim 1, wherein the horizontally stacking pleats comprising a front pleat, each pleat having a bottom; the bottom of each pleat being substantially even with the bottom of the front pleat when the panel is fully raised.

3. The panel of claim 1, wherein the sleeve is a tab-backed sleeve positioned at or near the top of the panel.

4. The panel of claim 5, wherein the sleeve extends continuously along the top of the panel.

5. The panel of claim 1, wherein the sleeve comprises at least two separate sections positioned at or near the top of the panel.

6. The panel of claim 1, wherein the sleeve comprises multiple tabs extending laterally along at or near the top of the panel.

7. The panel of claim 1, wherein the panel comprises one or more materials selected from the group consisting of natural fabric or synthetic fabric.

8. The panel of claim 7, wherein the natural fabric is cotton, linen or silk.

9. The panel of claim 7, wherein the synthetic fabric is polyester or nylon.

10. The panel of claim 1, wherein, the panel is a room divider.

11. The panel of claim 1, wherein the panel is a wall hanging.

12. The panel of claim 1, further comprising a planar bottom edge.

13. The panel of claim 1, wherein the length of the panel is about 30 inches, about 35 inches, about 40 inches, about 52 inches, or about 72 inches.

14. The panel of claim 1, wherein the width of the panel is about 75 inches, about 72 inches, or about 84 inches.

15. The panel of claim 1, wherein the slat comprises a narrow strip.

16. The panel of claim 1, wherein the slat comprises a dowel.

17. The panel of claim 1, further comprising 2 to 10 slats.

18. The panel of claim 1, further comprising 2 to 6 pull cords.

19. A raisable window treatment suspendable from a rod, when raised the window treatment is free of ballooning; the window treatment comprising:
(i) a horizontally extending top and a horizontally extending bottom;
(ii) a front side and a back side;
(iii) a plurality of horizontally extending vertically spaced slats; the slats are positioned along the panel, the slats are substantially parallel to the top of the panel;
(iv) a sleeve positioned at or near the top of the window treatment to enable insertion of the rod through the sleeve for installation of the window treatment; the sleeve is adapted to enable the installation to be completed without collateral hardware;
(v) a plurality of rows of vertically spaced guide elements on the back side of the panel, and multiple pull cords secured at or near the bottom of the panel at laterally spaced locations corresponding to the row of guide elements, each pull cord passing through one row of vertically spaced guide elements from the bottom of the panel to the uppermost guide element, and then extending laterally along at or near of a top of the panel; the guide elements defining vertically spaced fold lines to form predetermined horizontally stacking pleats when the window treatment is raised, wherein the length of the pleats are substantially parallel to the top of the panel; and
(vi) when the pull cord is pulled downward, panel folds upon itself laterally along the fold lines defined by the guide elements; thereby forming a series of predetermined horizontally stacking pleats free of ballooning; the pleats gathering in a lateral direction on the back side of the panel, the pleats forming longitudinally extending folds.

20. The window treatment of claim 19, wherein the sleeve is a tab-backed sleeve positioned at or near the top of the panel.

21. The window treatment of claim 19, wherein the sleeve extends continuously along the top of the panel.

22. The window treatment of claim 19, wherein the sleeve comprises at least two separate sections positioned at or near the top of the panel.

23. The window treatment of claim 19, wherein the sleeve comprises multiple tabs extending laterally along at or near the top of the panel.

24. The window treatment of claim 19, wherein the panel comprises one or more materials selected from the group consisting of natural fabric or synthetic fabric.

25. The window treatment of claim 24, wherein the natural fabric is cotton, linen or silk.

26. The window treatment of claim 24, wherein the synthetic fabric is polyester or nylon.

27. The window treatment of claim 19, wherein the window treatment accommodates a plurality of window sizes when suspended.

28. The window treatment of claim 1, further comprising a planar bottom edge.

29. The window treatment of claim 19, wherein the length of the panel is about 30 inches, about 35 inches, about 40 inches, about 52 inches, or about 72 inches.

30. The window treatment of claim 19, wherein the width of the panel is about 75 inches, about 72 inches, or about 84 inches.

31. The window treatment of claim 19, wherein the slat comprises a narrow strip.

32. The window treatment of claim 19, wherein the slat comprises a dowel.

33. The window treatment of claim 19, further comprising 2 to 10 slats.

34. The window treatment of claim 19, further comprising 2 to 6 pull cords.

35. A raisable panel suspendable from a rod, when raised the panel is substantially free of ballooning; the panel comprising:
(i) a horizontally extending top and a horizontally extending bottom;
(ii) a front side and a back side;
(iii) a plurality of horizontally extending vertically spaced slats;
(iv) multiple rings at or near the top of the panel to enable insertion of the rod through the rings for installing and suspending the panel; the rings being adapted to enable installation of the panel to be completed without collateral hardware;
(v) a plurality of rows of vertically spaced guide elements on the back side of the panel, and multiple pull cords secured at or near the bottom of the panel at laterally spaced locations corresponding to the row of guide elements, each pull cord passing through one row of vertically spaced guide elements from the bottom of the panel to the uppermost guide element, and then extending laterally along at or near of the top portion of the panel; and
(vi) when the panel is raised, the panel folds upon itself laterally along fold lines defined by the guide elements, thereby forming a series of predetermined horizontally stacking pleats free of ballooning.

36. The panel of claim 35, wherein, the panel is a fabric panel.

37. The panel of claim 35, wherein, the panel is a room divider.

38. The panel of claim 35, wherein the panel is a wall hanging.

39. The panel of claim 35, further comprising a planar bottom edge.

40. The panel of claim 35, wherein the length of the panel is about 30 inches, about 35 inches, about 40 inches, about 52 inches, or about 72 inches.

41. The panel of claim 35, wherein the width of the panel is about 75 inches, about 72 inches, or about 84 inches.

42. The panel of claim 35, wherein the slat comprises a narrow strip.

43. The panel of claim 35, wherein the slat comprises a dowel.

44. The panel of claim 35, further comprising 2 to 10 slats.

45. The panel of claim 35, further comprising 2 to 6 pull cords.

46. A raisable window treatment suspendable from a rod, when raised the window treatment is free of ballooning, the panel comprising:
(i) a horizontally extending top and a horizontally extending bottom;
(ii) a front side and a back side;
(iii) a plurality of horizontally extending vertically spaced slats; the slats are positioned along the panel, the slats are substantially parallel with the top of the panel;
(iv) multiple rings at or near the top of the panel to enable insertion of the rod through the rings for installing and suspending the panel; the rings being adapted to enable installation of the panel to be completed without collateral hardware;
(v) a plurality of rows of vertically spaced guide elements on the back side of the panel, multiple pull cords secured at or near the bottom of the panel at laterally spaced locations corresponding to the row of guide elements, each pull cord passing through one row of vertically spaced guide elements from the bottom of the panel to the uppermost guide element, and then extending laterally along at or near a top of the panel; the guide elements defining vertically spaced fold lines to form predetermined horizontally stacking pleats when the panel is raised, wherein the length of the pleats are substantially parallel to the top of the panel; and
(vi) when the pull cord is pulled down, the window treatment folds upon itself laterally along the fold lines defined by the guide elements, thereby forming a series of predetermined horizontally stacking pleats free of ballooning; the pleats gathering in a lateral direction on the back side of the panel, the overlapping pleats forming longitudinally extending folds.

47. The window treatment of claim 46, wherein the panel is a fabric panel.

48. The window treatment of claim 46, wherein, the panel is a room divider.

49. The window treatment of claim 46, wherein the panel is a wall hanging.

50. The window treatment of claim 46, further comprising a planar bottom edge.

51. The window treatment of claim 46, wherein the length of the panel is about 30 inches, about 35 inches, about 40 inches, about 52 inches, or about 72 inches.

52. The window treatment of claim 46, wherein the width of the panel is about 75 inches, about 72 inches, or about 84 inches.

53. The window treatment of claim 46, wherein the slat comprises a narrow strip.

54. The window treatment of claim 46, wherein the slat comprises a dowel.

55. The window treatment of claim 46, further comprising 2 to 10 slats.

56. The window treatment of claim 46, further comprising 2 to 6 pull cords.

57. A raisable panel suspendable from a rod, when raised the panel is free of ballooning; the panel comprising:
(i) a horizontally extending top and a horizontally extending bottom;
(ii) a front side and a back side;
(iii) a plurality of horizontally extending vertically spaced slats; the slats are positioned along the panel, the slats are substantially parallel to the top of the panel;
(iv) a sleeve positioned at or near the top of the panel to enable insertion of the rod through the sleeve for installing and suspending the panel; the sleeve being adapted to enable installation of the panel to be completed without collateral hardware;
(v) means for raising and lowering the panel; and
(vi) when the panel is raised, the panel folds upon itself laterally forming a series of predetermined horizontally stacking pleats free of ballooning, billowing.

58. The panel of claim 57, wherein the horizontally stacking pleats comprising a front pleat, each pleat having a bottom; the bottom of each pleat being substantially even with the bottom of the front pleat when the panel is fully raised.

59. The panel of claim 57, wherein the sleeve is a tab-backed sleeve positioned at or near the top of the panel.

60. The panel of claim 57, wherein the sleeve extends continuously along the top of the panel.

61. The panel of claim 57, wherein the sleeve comprises at least two separate sections positioned at or near the top of the panel.

62. The panel of claim 57, wherein the sleeve comprises multiple tabs extending laterally along at or near the top of the panel.

63. The panel of claim 57, wherein the panel comprises one or more materials selected from the group consisting of natural fabric or synthetic fabric.

64. The panel of claim 63, wherein the natural fabric is cotton, linen or silk.

65. The panel of claim 63, wherein the synthetic fabric is polyester or nylon.

66. The panel of claim 57, wherein the panel is a window treatment.

67. The panel of claim 57, wherein, the panel is a room divider.

68. The panel of claim 57, wherein the panel is a wall hanging.

69. The panel of claim 57, further comprising a planar bottom edge.

70. The panel of claim 57, wherein the length of the panel is about 30 inches, about 35 inches, about 40 inches, about 52 inches, or about 72 inches.

71. The panel of claim 57, wherein the width of the panel is about 75 inches, about 72 inches, or about 84 inches.

72. The panel of claim 57, wherein the slat comprises a narrow strip.

73. The panel of claim 57, wherein the slat comprises a dowel.

74. The panel of claim 57, further comprising 2 to 10 slats.

75. The panel of claim 57, further comprising 2 to 6 pull cords.
